(19) United States
(12) Patent Application Publication
(10) Pub. No.: US 2024/0106252 A1
(43) Pub. Date: Mar. 28, 2024

(54) PORTABLE CHARGING STATION

(71) Applicant: MILWAUKEE ELECTRIC TOOL CORPORATION, Brookfield, WI (US)

(72) Inventors: Christopher S. Spaulding, Green Bay, WI (US); Colin J. Roberts, Brookfield, WI (US); Isabel M. Lloyd, West Allis, WI (US); Matthew N. Thurin, Richfield, WI (US); Ameya Sanjay Kulkarni, Brookfield, WI (US); Brandon L. Yahr, Slinger, WI (US); Shreyas Sridar, Milwaukee, WI (US); Seamus J. Herson, Wauwatosa, WI (US)

(21) Appl. No.: 18/474,409

(22) Filed: Sep. 26, 2023

Related U.S. Application Data
(60) Provisional application No. 63/410,178, filed on Sep. 26, 2022.

(51) Int. Cl. H02J 7/00; H01M 50/247; H01M 50/256; H01M 50/262; H02J 7/34

(52) U.S. Cl. CPC H02J 7/0045; H01M 50/247; H01M 50/256; H01M 50/262; H02J 7/00032; H02J 7/0013; H02J 7/342; H01M 2220/30

(57) ABSTRACT

A portable power unit includes a base module, a pair of wheels coupled to the base module, and a main core battery disposed in the base module. A portable charger is removably coupled to the base module and includes a charger core battery, a battery receptacle electrically coupled to the charger core battery and configured to mechanically and electrically couple to a battery pack, and a cover movable to selectively allow access to the battery receptacle. The main core battery is electrically couplable with the charger core battery or the battery receptacle.

### CROSS REFERENCE TO RELATED APPLICATIONS

This application is based on and claims priority to U.S. Provisional Patent Application Ser. No. 63/410,178, filed Sep. 26, 2022, the disclosure of which is incorporated herein by reference in its entirety.

### FIELD

Embodiments described herein relate to charging stations used to recharge removable batteries, for example power tool battery packs.

### BACKGROUND

Rechargeable batteries are used to provide electrical power to a variety of devices (handheld power tools, lighting equipment, lawn mowers, fans, etc.). The batteries may be removably coupled to the device so the battery can be removed and recharged. Some battery chargers may be attached to a wall outlet by an electrical cord and may include an AC-to-DC converter to provide DC power to the battery.

### SUMMARY

The present disclosure provides, in one aspect, a portable power unit including a base module, a pair of wheels coupled to the base module, and a main core battery disposed in the base module. A portable charger is removably coupled to the base module and includes a charger core battery, a battery receptacle electrically coupled to the charger core battery and configured to mechanically and electrically couple to a battery pack, and a cover movable to selectively allow access to the battery receptacle. The main core battery is electrically couplable with the charger core battery or the battery receptacle.

The present disclosure provides, in another aspect, a portable power unit including a base module, a main core battery disposed in the base module, a pair of wheels coupled to the base module, a handle extending from the base module, and a charger disposed in the base module and electrically coupled to the main core battery. The charger includes a cavity, a cover movable to selectively allow access to the cavity, and a battery receptacle disposed in the cavity and electrically coupled to the main core battery. The battery receptacle is configured to mechanically and electrically couple to a battery pack.

The present disclosure provides, in another aspect, a portable charger including a case, a battery receptacle disposed within the case and configured to mechanically and electrically couple to a battery pack, a cover coupled to the case to selectively allow access to the battery receptacle; and a charger core battery coupled to an exterior of the case and electrically couplable to the battery receptacle.

The present disclosure provides, in one aspect, a portable power unit including a detachable charger. The present disclosure provides, in another aspect, a portable power unit with security features. The present disclosure provides, in another aspect, a portable power unit that can connect to a charging dock to charge and secure the unit and batteries. The present disclosure provides, in another aspect, a docking station for coupling to the portable power unit to secure the unit and charge the batteries. The present disclosure provides, in another aspect, a portable charger capable of interfacing with a storage system. The present disclosure provides, in another aspect, a portable charger with a removable core battery.

Other features and aspects of the disclosure will become apparent by consideration of the following detailed description and accompanying drawings.

### BRIEF DESCRIPTION OF THE DRAWINGS

FIG. 1 is a perspective view of a portable power unit according to a first embodiment of the disclosure including a base module and a detachable charger.

FIG. 2 illustrates a lock that secures the detachable charger and the base module of FIG. 1.

FIG. 3 is a perspective view of the detachable charger of FIG. 1 detached from the base module and having a cover removed.

FIG. 4 is a front view of a second embodiment of a portable power unit.

FIG. 5 illustrates the portable power unit of FIG. 4 being loaded onto a raised surface.

FIG. 6 is a side view of a third embodiment of a portable power unit.

FIG. 7 is a front view of a docking station for use with a portable power unit, such as the portable power unit of FIG. 6.

FIG. 8 is a perspective view of a fourth embodiment of a portable power unit including a portable charger coupled to a battery of a first type.

FIG. 9 illustrates a second embodiment of a portable charger, like the portable charger of FIG. 8, removably coupled to a battery of a second type.

FIG. 10 illustrates a third embodiment of a portable charger, like the portable charger of FIG. 8, removably coupled to a battery of a third type.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### DETAILED DESCRIPTION

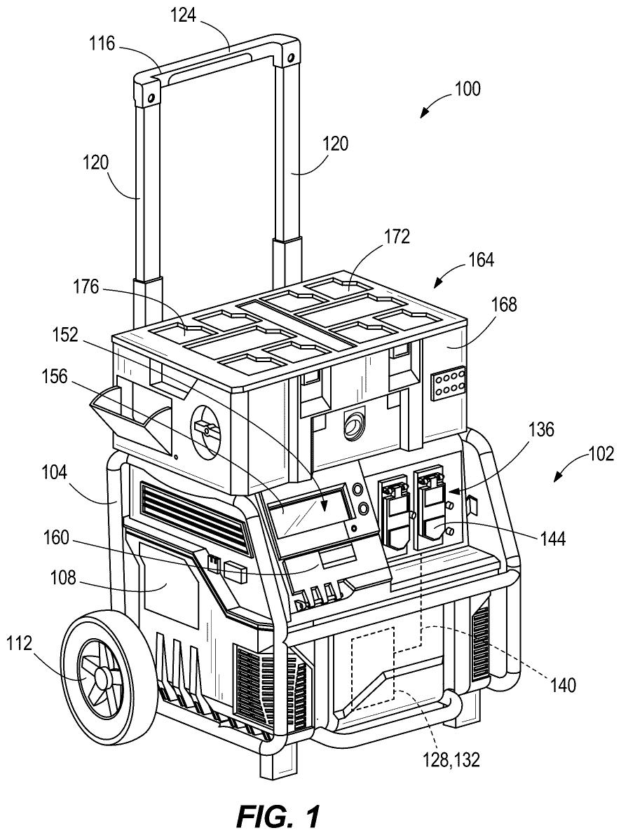

FIGS. 1-10 illustrate various embodiments of portable power units and chargers. While specific embodiments are described including specific features, the features of each embodiment may be incorporated into the design of any other embodiment without departing from the scope of this disclosure. Combinations of the disclosed designs are, therefore, contemplated.

FIGS. 1-3 illustrate a first embodiment of a portable power unit 100. As seen in FIG. 1, the portable power unit 100 includes a base module 102 with a frame 104 surrounding a housing 108. The frame 104 may be formed from metal, or from another strong material, and surrounds the housing 108 to prevent damage to the housing 108 or the components within. The frame 104 may be coupled by a tether (e.g., a chain, cable, etc.) to a permanent fixture to secure the portable power unit 100 and prevent theft. A pair of wheels 112 and a handle 116 are mounted to the frame 104. In the illustrated embodiment, the wheels 112 may include a tire or other textured surface to improve wheel performance in rugged environments. In the illustrated embodiment, the handle 116 is an extendable handle including a pair of telescoping supports 120 coupled to a grip 124. In other embodiments, the handle 116 may be removably coupled to the frame 104 or may otherwise be movable between a storage position and a deployed position. In the deployed position, the handle 116 can be used to tip the portable power unit 100 backwards (pivoting around the wheels 112), so that the portable power unit 100 can be rolled on the wheels 112 across a worksite or other rough terrain.

With continued reference to FIG. 1, the portable power unit 100 includes a power source 128 positioned in the housing 108. In the illustrated embodiment, the power source 128 includes a main core battery 132. In some embodiments, the main core battery 132 may be removable from the housing 108. In other embodiments, the main core battery 132 may be integrated into the housing 108. The main core battery 132 is rechargeable. The housing 108 also includes a power connection port 136 and a power circuit 140 that electrically couples the power source 128 to the port 136. In the illustrated embodiment, the port 136 includes one or more outlets 144 that may couple to a plug of a power cord. The outlets 144 may be AC power outlets of any standard configuration. In other embodiments, the port 136 may include additional or alternative types of outlets and electrical connections, including DC connections like USB, USB-C, and the like. One or more electrical devices may be coupled to the port 136 and electrically coupled to the power source 128 via the power circuit 140. In some embodiments, the electrical devices are powered by the power source 128. In some embodiments, the electrical devices include on-board batteries that are recharged by the power source 128. While the power source 128 is discussed as being a rechargeable battery, in other embodiments, the power source 128 may include a generator or other type of power supply. In embodiments where the power source 128 and the port 136 have different current types (e.g., AC and DC), the power circuit 140 includes an AC/DC converter circuit.

With continued reference to FIG. 1, the housing 108 further includes a user interface 152. In the illustrated embodiment, the user interface 152 includes a display 156 and controls 160. The user interface 152 provides information to the user about the portable power unit 100. For example, the user interface 152 may provide information about the power source 128 (e.g., a charge state of the main core battery 132, etc.). The portable power unit 100 may include additional components (e.g., a radio, one or more speakers, one or more sensors, one or more additional lights or displays, etc.) that are controlled by the user interface 152. The portable power unit 100 includes a portable charger 164 (also referred to herein as a detachable charger) coupled to the housing 108. In the illustrated embodiment, the portable charger 164 includes a main body, or body, 168 and a cover 172 coupled to the body 168. The body 168 and cover 172 each include a set of connectors, or fasteners, 176 configured to interface with other units in a storage and transport system. For example, the portable charger 164 may have connectors consistent with the PACKOUT™ system by Milwaukee®. Each set of connectors 176 may include one or more male fasteners and/or one or more female fasteners. For example, the cover 172 may include a set of connection recesses. The body 168 may include a set of connection projections or cleats. Similarly, the housing 108 may include a set of connectors on an upper surface similar to the connectors 176 on the cover 172 of the portable charger 164. Thus, the connectors 176 located on a bottom surface of the body 168 interface with the connectors on the housing 108 to removably secure the portable charger 164 to the housing 108. In other words, the connectors 176 located on the bottom surface of the body 168 have a complementary configuration to the connectors 176 located on the housing 108 and to the connectors 176 located on the cover 172. In other embodiments, the portable charger 164 may be otherwise removably coupled to the housing 108.

With continued reference to FIG. 1, the portable charger 164 is also electrically connectable to the housing 108. In the illustrated embodiment, the bottom surface of the body 168 also includes electrical contacts configured to couple to corresponding electrical contacts on the upper surface of the housing 108. The electrical contacts may be integrated with or separate from the connectors 176. In some embodiments, the portable charger 164 is electrically connected to the power circuit 140 of the housing 108 through a power cord coupled to the port 136. In other embodiments, the electrical connection may be achieved through different means.

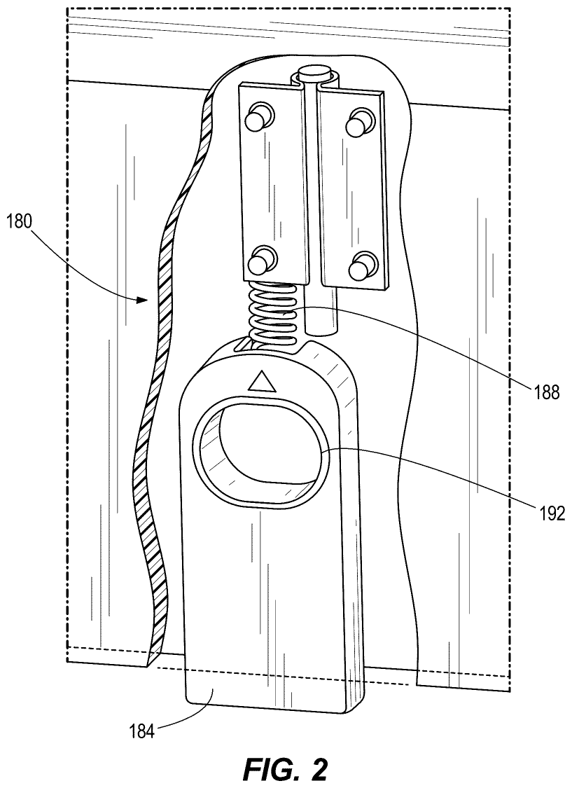

Turning now to FIG. 2, in some embodiments, the connectors 176 removably couple the portable charger 164 to the housing 108, and a lock 180 is provided to secure the portable charger 164 to the housing 108. The lock 180 may include a sliding latch 184 and a spring 188. The spring 188 biases the sliding latch 184 to extend from a bottom of the portable charger 164 and engage a corresponding feature on the housing 108. The lock 180 may automatically engage the housing 108 upon coupling of the portable charger 164 to the housing 108, or may be manually engaged by a user. To disengage the lock 180 so that a user is able to remove the detachable charger 164, the sliding latch 184 may be pulled against the biasing force of the spring 188 to disengage the corresponding feature on the housing 108. In the illustrated embodiment, the sliding latch 184 includes an opening 192 for receiving a finger of a user to allow the user to pull the sliding latch 184. In FIG. 2, portions of the body 168 are removed to show the lock 180. In regular use, the lock 180 is not visible or accessible from the outside of the portable charger 164. Instead the lock 180 may only be disengaged when the cover 172 is removed and the interior of the portable charger 164 can be accessed. The lock 180 prevents theft or unwanted removal of the portable charger 164 from the housing 108. The portable charger 164 includes a cover lock (not shown) to secure the cover 172 to the body 168 and inhibit unauthorized access to the interior of the portable charger 164 and the lock 180.

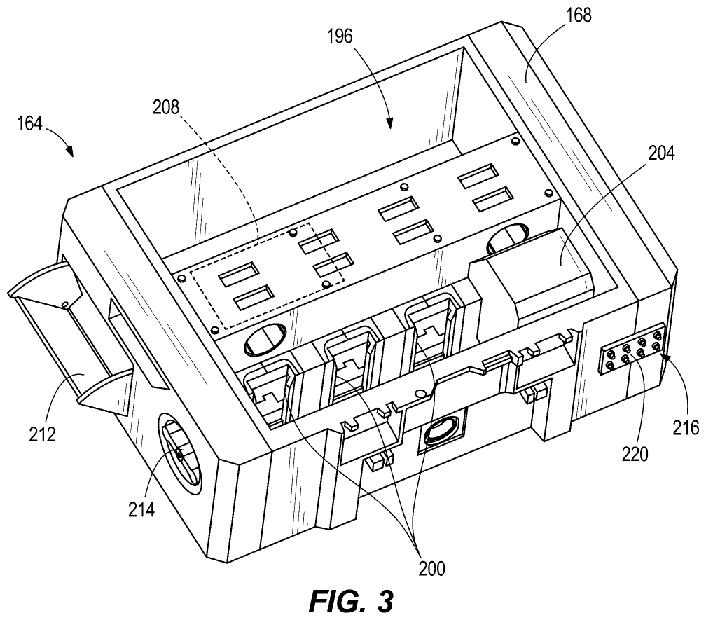

FIG. 3 illustrates the portable charger 164 detached from the housing 108 with the cover 172 removed. The body 168 of the portable charger 164 defines a cavity 196 including a plurality of battery receptacles 200. In the illustrated embodiment the cover 172 is removably coupled to the body 168, however, in other embodiments, the cover 172 may instead be movably (e.g. hingedly) coupled to the body 168. In either case, the cover 172 is movable between a closed position, in which access to the cavity 196 is inhibited, and an open position, in which access to the cavity 196 is permitted. Each battery receptacle 200 positioned in the cavity 196 selectively receives a removable, rechargeable battery, or battery pack, 204. For example, the battery receptacle 200 may connect to a lithium-ion power tool battery pack. The battery pack(s) 204 may be removed from the portable charger 164 and coupled to a variety of electronic devices (e.g., handheld power tools, fans, lights, etc.) to provide power to the electronic device. In some embodiments, each battery receptacle 200 may receive a single type of battery. In other embodiments, each battery receptacle 200 may include contacts to couple to multiple types of batteries. In the illustrated embodiment, the cavity 196 contains eight of the battery receptacles 200, including six battery receptacles 200 configured to couple to a first type of battery (e.g., an M18™ Battery) and two battery receptacles 200 configured to couple to both the first type of battery and a second type of battery (e.g., an M12™ Battery). In other embodiments, the cavity 196 may contain more or fewer than eight battery receptacles and may include battery receptacles with different configurations.

With continued reference to FIG. 3, the detachable charger 164 includes a charger core battery 208. When the detachable charger 164 is coupled to the housing, the main core battery 132 is electrically coupled to the charger core battery 208 through the electrical contacts and the power circuit 140. The main core battery 132 may, therefore, recharge the charger core battery 208. In some embodiments, the detachable charger 164 may additionally include a power port that may be coupled to a power source to recharge the charger core battery 208. In some embodiments, the charger core battery 208 may be removably coupled to the body 168, and may be couplable to another charger or power source to recharge. In some embodiments, including the illustrated embodiment, the charger core battery 208 may be integrated into the body 168. In other embodiments, the charger core battery 208 may be removably coupled to the portable charger 164 within the cavity 196. In still other embodiments, the charger core battery 208 may be otherwise coupled to the portable charger 164. The charger core battery 208 is electrically coupled to each of the battery receptacles 200 to provide power to the attached battery packs 204. In some embodiments, the charger core battery 208 may be controlled to provide power to the battery receptacles 200 simultaneously or according to a charging hierarchy (e.g., providing more power to certain receptacles 200, or providing power sequentially to receptacles 200 based on importance, etc.). In some embodiments, when the detachable charger 164 is electrically coupled to the housing 108, the main core battery 132 may be used to provide power to the receptacles 200, bypassing the charger core battery 208 to maintain a charged status of the charger core battery 208.

The detachable charger 164 may include a cord pocket 212 configured to receive and store cords not in use, or extra length of in-use cords to decrease tripping hazards in the worksite. In the illustrated embodiment, the cord pocket 212 is located on an exterior sidewall of the main body 168. In some embodiments, the cord pocket 212 may be adjacent an opening in the body 168 providing access to the cavity 196, and the cords may extend from inside the cavity 196. The detachable charger 164 further includes a reel 214 for a security cable. In some embodiments, the security cable may be anchored to a permanent fixture or to the frame 104 of the housing 108 to inhibit unauthorized movement of the detachable charger 164 and decrease the likelihood of theft of the detachable charger 164. The detachable charger 164 may be a handheld case and includes a handle (not shown) graspable by a user to easily transport (e.g., carry) the detachable charger 164 across a worksite. The detachable charger 164 may include additional features coupled to the exterior of the body 168. For example, the detachable charger 164 may include a set of hooks or racks couplable to tools or accessories to easily support the tools or accessories adjacent the charger. The detachable charger 164 may include additional pouches for receiving tools, hardware, or other accessories. The detachable charger 164 may include a pouch or other external support to temporarily hold charged battery packs 204 for easy access during a workday. The charged battery packs 204 may be moved back within the cavity 196 overnight and when otherwise left unattended. The detachable charger 164 may include one or more mounting feature which engage a wall rack to support the detachable charger 164 on a wall and above the ground. The detachable charger 164 may include still further features for improving efficiency at a worksite and easily transporting relevant components with the detachable charger 164.

With continued reference to FIG. 3, the detachable charger 164 includes a display 216 for communicating information to the user about the battery packs 204 coupled to the battery receptacles 200 and/or information about the charger core battery 208. In the illustrated embodiment, the display 216 includes LEDs 220 indicating the charging state of the attached battery packs 204. Specifically, the display 216 includes eight LEDs 220, each associated with one of the eight receptacles 200 within the cavity 196. The color and state of the LEDs may communicate information according to an established scheme. In one exemplary scheme, the LEDs 220 may be RGB LEDs and may illuminate a GREEN color to indicate the attached battery 204 is charged, a YELLOW color to indicate the attached battery 204 is charging, or a RED color to indicate an error with the attached battery 204 or an empty battery receptacle 200. In some embodiments, a lack of illumination in an LED may indicate an empty battery receptacle 200. In some embodiments, the LEDs may utilize flashing patterns instead of colors to indicate the charge state of the attached batteries 204. Additionally, the LEDs may flash or light a specific color in unison to indicate a status of the charger core battery 208. In some embodiments, the LEDs may be constantly illuminated. In other embodiments, the LEDs may be prompted to illuminate based on an input such as the cover being removed, a button or control being actuated, one of the battery packs 204 being attached to one of the receptacles 200, etc. In some embodiments, the display 216 may include additional or alternative display parts such as a display screen and/or touch screen. The information provided by the display 216 can be used to determine the charge status of the attached battery packs 204 without removing or moving the cover 172 to reveal the cavity 196.

The portable power unit 100 illustrated in FIGS. 1-3 is easily transported across a worksite, is configured to provide power to a variety of devices, and includes the detachable charger 164 removably coupled to the housing 108 which allows a user to charge a variety of batteries on the go and easily move the detachable charger 164 across the worksite.

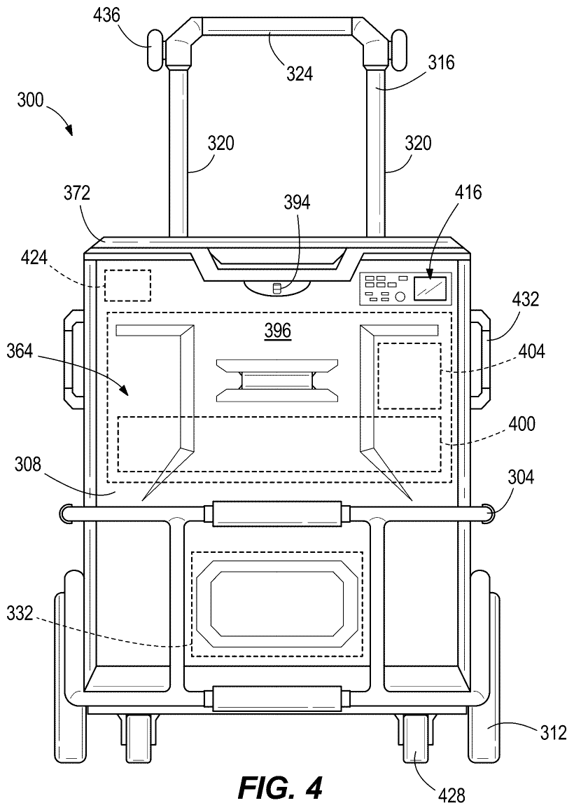

FIG. 4 illustrates a portable power unit 300 according to another embodiment. The portable power unit 300 includes a frame 304 and a housing 308 supported by the frame 304. In the portable power unit 300 illustrated in FIG. 4, a charger 364 (similar to the detachable charger 164 of the portable power unit 100) is integrated into the housing 308. Thus, the portable power unit 300 includes similar features and parts to the portable power unit 100, and similar parts are indicated with similar reference numbers plus 200.

The portable power unit 300 further includes a pair of wheels 312 coupled to the frame 304, and a handle 316 extending up from the frame 304. Similar to the handle 116 of the portable power unit 100, the handle 316 includes a pair of telescoping supports 320 and a grip 324. The telescoping supports 320 allow the handle 316 to move between a collapsed position and an extended position. In other embodiments, the handle 316 may take other forms and may otherwise be stowable.

As discussed above, the charger 364 is integrated into the housing 308. The housing includes a cover 372 which selectively permits access to a cavity 396. The charger 364 includes a plurality of battery receptacles 400. The receptacles 400 are each configured to couple to a rechargeable battery, or battery pack, 404. The illustrated embodiment includes a similar configuration to the detachable charger 164, having six single-type receptacles and 2 combo- or multi-type receptacles. In other embodiments, the plurality of battery receptacles 400 may include any number of receptacles of any configuration. In the portable power unit 300, the housing 308 includes a main core battery 332 in electrical communication with the battery receptacles 400. As discussed in reference to the portable power unit 100, the main core battery 332 may provide power to the attached rechargeable batteries 404 which may be removed and coupled to electronic devices to provide power thereto. The housing 308 includes a display 416 which communicates information about the batteries 332, 404 to the user (e.g., a human-machine interface, HMI, display). The portable power unit 300 may include a wireless communication device 424 to provide information about the power unit 300 and the attached battery packs 404 to a user via an electronic device (e.g., a smart phone, a tablet, a computer, etc.). For example, the portable power unit 300 may be integrated with the One-Key™ system by Milwaukee® to allow users to track, secure, and gain insights into their battery usage through the One-Key™ application. In some embodiments, the wireless communication device 424 may provide GPS or other location tracking, and may allow for remote deactivation to aid in recovery of the portable power unit 300 if stolen.

The cover 372 is movable between a closed position, in which access to the cavity 396 is inhibited, and an open position, in which access to the cavity 396 is permitted. In some embodiments, the cover 372 may be removably coupled to the housing 308. In other embodiments, the cover 372 may be movably (e.g., hingedly) coupled to the housing 308 for movement between the open and closed positions. The cover 372 is secured in the closed position by a cover lock 394. The cover 372 and cover lock 394 prevent unauthorized access to the cavity 196 and protect the contents (e.g., the batteries 404) from theft.

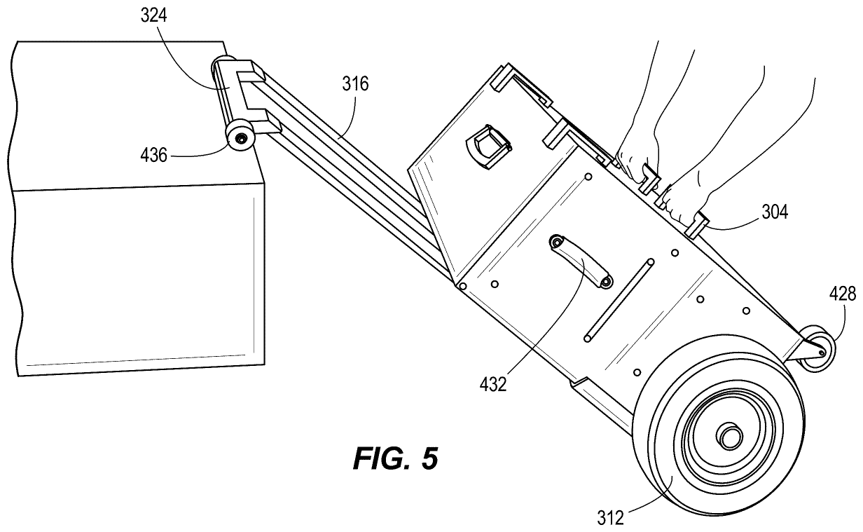

With reference to FIG. 5, the portable power unit 300 includes a number of features which enhance maneuverability of the power unit 300. The wheels 312 may be pneumatic wheels and may include tire treads for improving maneuverability over rough terrain and stairs. Additionally, the wheels 312 may be lockable to prevent unauthorized transport of the portable power unit 300 and inhibit theft. The portable power unit 300 may additionally include caster wheels 428 coupled to one of the housing 308 or the frame 304 to increase maneuverability in tight spaces. The housing 308 may include secondary handles 432 extending from either side of the housing 308, and the secondary handles 432, the frame 304, and the handle 316 provide multiple grab points to increase the ease of lifting the portable power unit 300 (for example, into a vehicle or up a set of stairs). The handle 316 includes a pair of rollers 436 positioned on either side of the grip 324 which enable a single user to load the portable power unit 300 onto a raised surface (e.g., a truck bed) without assistance.

Thus, the power unit 300 of FIGS. 4 and 5 provides an easily transported and highly maneuverable portable power unit for securely retaining and recharging a large number of batteries.

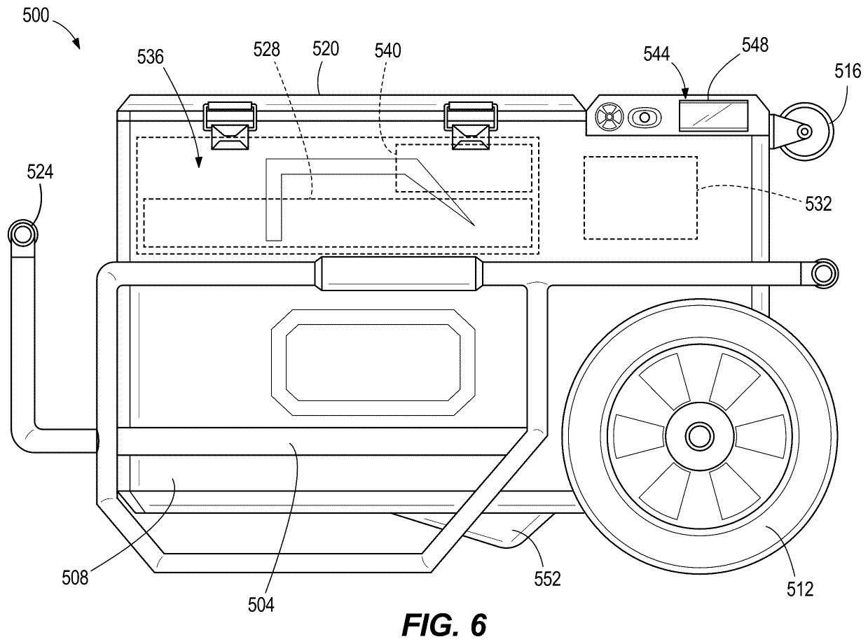

FIG. 6 is a side view of a portable power unit 500 according to another embodiment. The portable power unit 500 includes a frame 504, a housing 508, a set of wheels 512 coupled to either the frame or the housing, a set of caster wheels 516 coupled to the housing, a lid 520 coupled to the housing, and an adjustable handle 524. The adjustable handle 524 has an adjustable length to accommodate users of different heights and to use in moving the unit 500 in different ways. The frame 504 may cooperate with the wheels 512 to support the portable power unit 500 in a lateral orientation on a surface. The handle 524 may be used to lift one end of the portable power unit 500 and roll the wheels 512 across the surface (e.g., like a cooler). The handle 524 may also be used to lift the portable power unit 500 into a vertical orientation, where the wheels 512 and the caster wheels 516 cooperate to support the housing 508 on the surface. The handle 524 may be used to maneuver the unit 500 through tight spaces (e.g., vans, truck beds, crowded worksites, hallways, doorways, etc.). Thus, the changeable orientation provides the portable power unit 500 with greater maneuverability through tight spaces in the vertical orientation and greater maneuverability over difficult terrain in the lateral orientation. The housing may include a stop feature 552 positioned on the lower surface (in the lateral configuration) of the housing 308. The stop feature 552 may include an angled surface configured to engage a stair or step to prevent out-of-control movement of the portable power unit 500 down the steps during transport up or down a staircase.

The power unit 500 includes a set of battery receptacles 528 for removably receiving a rechargeable battery 540 connected to a main core battery 532. The lid 520 selectively provides access to a cavity 536 containing the battery receptacles 528. In the illustrated embodiment, the plurality of battery receptacles 528 includes five receptacles for connecting to a first type of battery and one receptacle for connecting to a first type of battery and a second type of battery. The lid 520 can be locked to prevent batteries 540 attached to the battery receptacles 528 from being removed from the cavity 536. The portable power unit 500 includes a user interface 544 that communicates information about the batteries 532, 540 to a user, such as a charging status of the attached batteries 540 or the main core battery 532. The portable power unit 500 may include a docking port 548 on one side of the housing 308, such that the portable power unit 500 may be coupled to a docking station which may provide power to the main core battery 532 and/or the batteries 540 attached to the receptacles 528. The docking port 548 may include a locking feature to prevent unauthorized removal from the docking station to prevent theft.

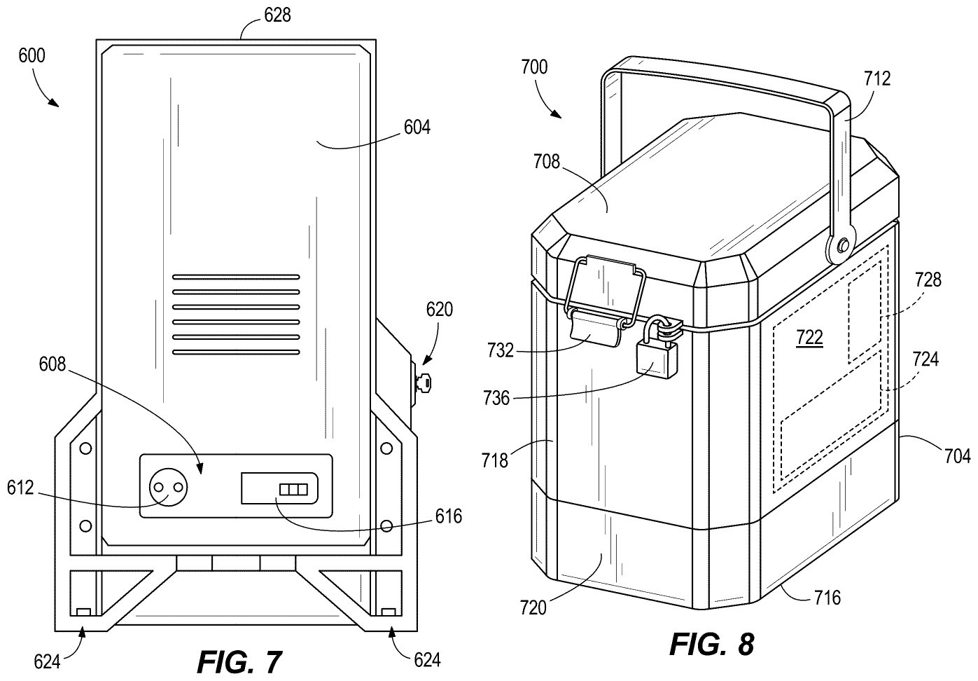

FIG. 7 illustrates a docking station 600 for use with the portable power unit 500 of FIG. 6. The docking station 600 includes a housing 604 with a connection interface 608 including a DC charging receptacle 612 that connects to a power source and an internal charging circuit contained within the housing 604. The portable power unit 500 can, therefore, be lightweight, as the components to charge the main core battery 532 are contained in the docking station 600 rather than carried on the portable power unit 500. Additionally, the power unit 500 can be charged without cords by simply coupling the docking port 548 with the charging receptacle 612. The connection interface 608 further includes a locking feature 616 that connects to the locking feature on the portable power unit 500 to secure the portable power unit 500 to the docking station 600 and prevent unauthorized removal. The locking feature 616 may include a latch that is releasable by an actuator 620. In some embodiments, the actuator 620 is a handle positioned on the docking station 600. In some embodiments, the actuator 620 may be positioned within the housing 604 of the docking station. In some embodiments, the actuator 620 may be electronically actuated to release the locking feature 616. When the docking station 600 is coupled to the portable power unit 500, the docking station 600 abuts the lid 520 so that the lid 520 is unable to open, and access to the attached batteries 540 is inhibited.

The docking station 600 is typically permanently positioned in a secure location. The docking station 600 is mounted to the wall or to the floor by internal mounting features 624 to secure the station. In some embodiments, the mounting features 624 may include threaded fasteners. In other embodiments, the mounting features 624 may utilize other types of connection methods.

The docking station 600 may include a user interface 628 that communicates information to the user. For example, the user interface 628 may display a status of the connection between the docking station 600 and the portable power unit 500 and a charging status of the main core battery 532 of the portable power unit 500. In some embodiments, the docking station 600 may include a charger configured to directly couple to large batteries, such as the main core batteries 532, 332, 132 or the charger core battery 208. In these embodiments, the user interface 628 may communicate additional information about the attached batteries.

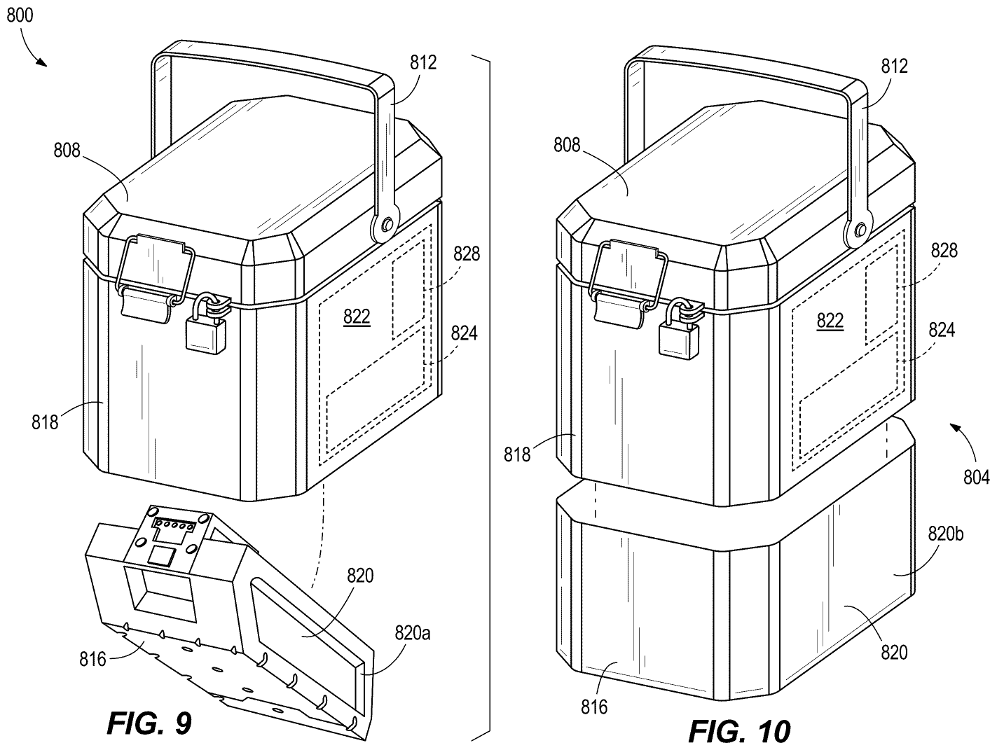

FIG. 8 illustrates a portable charger 700 with a housing 704, a cover 708, and a handle 712. The portable charger 700 is easily carried by the handle 712 across a worksite. In the illustrated embodiment the handle 712 is pivotally coupled to the cover 708. In other embodiments, the handle 712 may be coupled directly to the housing 704. The housing 704 includes mounting features 716 that allow the portable charger 700 to interface with a storage and transport system (e.g., the PACKOUT™ system by Milwaukee®). The housing 704 includes a case 718 and a charger core battery 720 coupled to the case 718. The cover 708 is coupled to a top end of the case 718. In the illustrated embodiment, the charger core battery 720 is coupled to an exterior of the case 718, at a bottom end, opposite the cover 708. In the illustrated embodiment, the charger core battery 720 is either integrated into the case 718 or permanently coupled to the case 718 to form the housing 704. The housing 704 is generally box shaped, giving the overall portable charger 700 a “lunchbox” configuration. In other embodiments (such as in FIGS. 9-10), the charger core battery 720 may be removable from the case 718.

The case 718 of the housing 704 includes a cavity 722 containing one or more battery receptacles 724 configured to receive a rechargeable battery 728. In the illustrated embodiment, the cavity 722 contains three receptacles configured to couple to a first type of battery. In other embodiments, there may be more or fewer than three receptacles of varying configurations. Each battery receptacle 724 is electrically coupled with the charger core battery 720 to provide power from the charger core battery 720 to the attached battery 728. In some embodiments, the portable charger 700 can be alternated between a first mode, in which the attached battery 728 is charged by the charger core battery 720, and a second mode, in which the attached battery 728 charges the charger core battery 720. In some embodiments, the portable charger 700 may include a port for coupling to a separate power source (e.g., an AC power cord plugged into the wall). When coupled to the separate power source, the charger core battery 720 and any attached battery 728 may both be recharged by the power source, either simultaneously or sequentially. The cover 708 is movable between an open position and a closed position, in which the batteries 728 are protected. The cover 708 may be secured in the closed position by a latch 732 and/or a lock 736.

The portable charger 700 is easily transported to and around a worksite, either as part of a set of storage units from a system, or as an individual unit. The charger core battery 720 may be carried by the handle 712 alongside a user from site to site, and may be used to recharge the battery packs 728 along the way. The small form factor of the charger 700 increases the ease of transporting the charger 700 and of storing the charger 700 in a secure location (such as inside a docking station 600, a worksite box, or the like). Additionally, the handle 712 is sturdy enough to be lifted by heavy machinery, allowing for more ways to transport the charger 700.

FIGS. 9 and 10 illustrate another embodiment of a portable charger 800. The portable charger 800 is similar to the portable charger 700, and, for brevity's sake, only differences between the embodiments are described in detail herein. Similar features use similar reference numbers plus 100. The portable charger 800 includes a housing 804, a cover 808, and a handle 812 pivotably coupled to the cover 808. The housing 804 includes a charger core battery 820 coupled to a bottom end of a case 818. The charger core battery 820 is removably coupled to the bottom end of the case 818. A set of battery receptacles 824 are positioned in a cavity 822 and each are able to mechanically support and electrically couple to a battery pack 828. The set of battery receptacles 824 are electrically connected to the charger core battery 820 while the charger core battery 820 is coupled to the case 818. The charger core battery 820 may be one of a set of charger core batteries of different sizes (e.g., different voltages or currents). FIG. 9 illustrates a charger core battery 820a of a first type. In the illustrated embodiment, the first charger core battery 820a has a power level or capacity of 400 Watt-Hours (WH). FIG. 10 illustrates a charger core battery 820b of a second type. In the illustrated embodiment, the second charger core battery 820b has a power level or capacity of 1,000 WH, or 1 kilowatt hour (KWH). In other embodiments, the portable charger 800 may include additional charger core batteries 820 of differing sizes. In some embodiments, the case 818 may couple to multiple charger core batteries 820 stacked together to increase the capacity of the portable charger 800. In some embodiments, the charger core battery 820 may be one of a set of charger core batteries all having different capacities, and the user can select a battery core based on the desired usage. In some embodiments, the portable charger 800 may also include an adapter configured to couple to the housing 804 alongside or in place of the charger core battery 820. The adapter may include an AC-DC converter and may allow the portable charger 800 to be connected to AC power (e.g., plugged into a wall outlet) to power the battery receptacles 824 and/or recharge the charger core battery 820. Alternately or additionally, the portable charger 800 may include an integrated AC-DC charger and a port configured to connect to AC power to charge the attached charger core battery 820 and the attached battery packs 828. In some embodiments, the charger core batteries 820 may be a large core battery (e.g., a MX Fuel™ battery) and the attached battery packs 828 may include smaller core batteries (e.g., M18™ battery, M12™ battery, etc.).

Thus, when the batteries 828 are coupled to the receptacles 824 and the charger core battery 820 is coupled to the case 800, the charger core battery 820 can supply electrical power to charge the attached batteries 828. When the charger core battery 820 is depleted, it can be removed and recharged, or replaced with another, fully charged, charger core battery 820. The charger core battery 820 may include an AC-DC converter circuit that allows the charger core battery 820 to couple to and be recharged by AC power. The charger core battery 820 and the cover 808 may each include mounting features 816 that allow the portable charger 800 to interface with a storage and transport system (e.g., the PACKOUT™ system by Milwaukee®).

The portable power units and chargers disclosed herein are capable of additional forms. Although the disclosure has been described in detail with reference to certain preferred embodiments, variations and modifications exist within the scope and spirit of one or more independent aspects of the disclosure as described.

1. A portable power unit comprising:
a base module;
a pair of wheels coupled to the base module;
a main core battery disposed in the base module; and
a portable charger removably coupled to the base module, the portable charger including
a charger core battery disposed therein,
a battery receptacle electrically coupled to the charger core battery and configured to mechanically and electrically couple to a battery pack, and
a cover movable to selectively allow access to the battery receptacle,
wherein the main core battery is electrically couplable with the charger core battery or the battery receptacle.

2. The portable power unit of claim 1, wherein the portable charger is removably coupled to the base module by a set of first connectors.

3. The portable power unit of claim 2, wherein the portable charger further includes a lock securable to the base module.

4. The portable power unit of claim 3, wherein
the lock includes a release actuator, and
the release actuator is accessible from inside the portable charger.

5. The portable power unit of claim 2, wherein
the set of first connectors are disposed on the portable charger and are engageable with a set of second connectors disposed on the base module,
the set of second connectors have a complementary configuration to the set of first connectors, and
each of the set of first connectors and the set of second connectors includes at least one male fastener or female fastener.

6. The portable power unit of claim 5, wherein
the cover includes a set of third connectors, and
the set of third connectors have a complementary configuration to the set of first connectors.

7. The portable power unit of claim 1, wherein
the portable charger includes a body defining a cavity,
the battery receptacle is one of a plurality of battery receptacles, and
the plurality of battery receptacles are positioned within the cavity.

8. The portable power unit of claim 1, wherein the main core battery is electrically couplable with the charger core battery and the battery receptacle simultaneously.

9. A portable power unit comprising:
a base module;
a main core battery disposed in the base module;
a pair of wheels coupled to the base module;
a handle extending from the base module;
a charger disposed in the base module and electrically coupled to the main core battery, the charger including
a cavity,
a cover movable to selectively allow access to the cavity, and
a battery receptacle disposed in the cavity and electrically coupled to the main core battery, the battery receptacle configured to mechanically and electrically couple to a battery pack.

10. The portable power unit of claim 9, wherein
the cover is movable to a closed position, and
the portable power unit includes a lock for securing the cover in the closed position.

11. The portable power unit of claim 9, wherein
the portable power unit includes a plurality of grip points for loading the portable power unit onto a raised surface, the plurality of grip points including a grip positioned on the handle, a frame of the base module, and a pair of secondary handles positioned on either side of the base module, and
the handle further includes a pair of rollers coupled to the grip and configured to roll across the raised surface while loading.

12. The portable power unit of claim 9, wherein
the pair of wheels is a first pair of wheels configured to support the portable power unit on a surface, and
the portable power unit further comprises a second pair of wheels.

13. The portable power unit of claim 12, wherein
the portable power unit is rotatable by the handle about the first pair of wheels, and
the portable power unit is movable between a lateral orientation, with the second pair of wheels above the first pair of wheels, and a vertical orientation, with both the first pair of wheels and the second pair of wheels oriented to contact the surface.

14. The portable power unit of claim 9, wherein the portable power unit includes a wireless communication device for communicating information about the battery pack and the portable power unit to an electronic device.

15. The portable power unit of claim 9, further comprising a docking port configured to mechanically and electrically couple the portable power unit to a docking station to recharge the main core battery.

16. The portable power unit of claim 15, wherein the docking port includes a lock configured to secure the portable power unit to the docking station.

17. A portable charger comprising:
a case;
a battery receptacle disposed within the case and configured to mechanically and electrically couple to a battery pack;
a cover coupled to the case to selectively allow access to the battery receptacle; and
a charger core battery coupled to an exterior of the case and electrically couplable to the battery receptacle.

18. The portable charger of claim 17, wherein the charger core battery is removably coupled to the exterior of the case.

19. The portable charger of claim 18, wherein
the charger core battery is removably couplable to the case at an end opposite the cover;
the charger core battery is a first charger core battery of a first battery type; and
a second charger core battery of a second battery type is removably couplable to the end of the case.

20. The portable charger of claim 17, further comprising a handle pivotably coupled to the case or the cover, and
wherein
the charger core battery includes a set of first connectors, and
the cover includes a set of second connectors complementary to the set of first connectors.
